(19) United States
(12) Patent Application Publication
(10) Pub. No.: US 2025/0224798 A1
(43) Pub. Date: Jul. 10, 2025

(54) Preserving Connections in Deep Lower-Power States of Network Devices

(71) Applicant: Cisco Technology, Inc., San Jose, CA (US)

(72) Inventors: Craig Wickham, Langley, BC (CA); Dinh Cat Ngoc Nguyen, San Jose, CA (US); Leila Reyhani; Dave Zacks, Vancouver, BC (CA); Nandini Maheshwari, San Jose, CA (US)

(21) Appl. No.: 18/408,559

(22) Filed: Jan. 9, 2024

(51) Int. Cl. G06F 1/3296; G06F 1/3209

(52) U.S. Cl. CPC G06F 1/3296; G06F 1/3209

(57) ABSTRACT

Devices, systems, methods, and processes for facilitating power savings by entering a lower-power state. Often, the lower-power state is able to power down more components than is typical but relying on a physical connection between the various network devices to retain the connection. This connection can be via a PHY connection in accordance with the OSI model. Additional components on the device can be powered down while avoiding the destruction of connections to neighboring network devices. In this configuration, the device in the lower-power state can wake and resume operations in a suitable timeframe. Often, this can be configured as a high-availability pair that can have one device active and another in deep standby to provide a failover configuration that utilizes less power than would otherwise be utilized in a traditional system. This can be expanded to devices that communicate wirelessly, but have a physical connection to a shared device.

The present disclosure relates to networking. More particularly, the present disclosure relates to allowing for deep power-saving standby states in network devices that can retain connections to neighboring devices.

### BACKGROUND

In many modern networking systems, network redundancy is critical because application uptime needs to be maximized to provide the best possible client experience. Network systems are often built with a high level of redundancy. That redundancy leads to various inefficiencies in terms of standby device power consumption and heat generation, which are often close to or equivalent to the amount utilized by the active device.

In these active/standby network architectures, standby devices need to maintain peer relationships and state data in order to take over the role of the active device with minimal delays if the active device fails or is purposefully taken offline for operations such as upgrades. Maintenance of such relationships and states often require that the standby device be fully powered, fully functional, and ready to take over if the active device fails. However, this duplicates the power draw and heat load of the system, producing inefficiencies and impacting sustainability. This causes network operators to choose between failover performance and sustainability if peer relationships are to be maintained.

### SUMMARY OF THE DISCLOSURE

Systems and methods for allowing for deep power-saving standby states in network devices that can retain connections to neighboring devices in accordance with embodiments of the disclosure are described herein. In some embodiments, a device includes a processor, at least one network interface controller configured to provide access to a network, and a memory communicatively coupled to the processor, wherein the memory includes a power-saving logic. The logic is configured to establish a connection link with at least one neighbor device, determine that it is suitable to enter a lower-power state, enter the lower-power state, and transmit a plurality of link pulses to the at least one neighbor device.

In some embodiments, the plurality of link pulses are continuous.

In some embodiments, the plurality of link pulses are transmitted at a predetermined interval.

In some embodiments, the power-saving logic is further configured to determine that it is suitable to exit the lower-power state, exit the lower-power state, and cease transmission of the plurality of link pulses.

In some embodiments, the connection link is based on the open system interconnection (OSI) model.

In some embodiments, the connection link is at the physical (PHY) layer.

In some embodiments, the connection link is a wired connection.

In some embodiments, the power-saving logic is further configured to receive a plurality of link pulses from the at least one neighbor device.

In some embodiments, the power-saving logic is further configured to count the number of received link pulses from the at least one neighbor device.

In some embodiments, the power-saving logic is further configured to compare the count of received link pulses against a predetermined threshold, and exit, in response to the count of received link pulses exceeding the predetermined threshold, the lower-power state.

In some embodiments, the power-saving logic is further configured to receive state data from the at least one neighboring device, and re-enter the lower-power state.

In some embodiments, the power-saving logic is further configured to determine a time interval since a last received link pulse.

In some embodiments, the power-saving logic is further configured to compare the time interval against a predetermined threshold, and exit, in response to the time interval exceeding the predetermined threshold, the lower-power state.

In some embodiments, the power-saving logic is further configured to receive state data from the at least one neighboring device, and re-enter the lower-power state.

In some embodiments, a device includes a processor, at least one network interface controller configured to provide access to a network, and a memory communicatively coupled to the processor, wherein the memory includes a power-saving logic. The logic is configured to establish a connection link with at least one neighbor device, receive state data associated with the at least one neighbor device, determine that it is suitable to enter a lower-power state, enter the lower-power state, exit, in response to an event, the lower-power state, initiate at least one operation based on the state data.

In some embodiments, the at least one operation is associated with the neighbor device.

In some embodiments, the at least one operation is configured to mimic an operation performed by the neighbor device.

In some embodiments, the event is receiving one or more link pulses configured to indicate a wakeup signal.

In some embodiments, the event is failing to receive a predetermined number of link pulses from the neighbor device in a predetermined time interval.

In some embodiments, a method of maintaining neighboring connections includes establishing a connection link with at least one neighbor device over a network, determining that it is suitable to enter a lower-power state, entering the lower-power state, and transmitting a plurality of link pulses to the at least one neighbor device, wherein the plurality of link pulses are configured to maintain a connection with the at least one neighbor device.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual network diagram of various environments that a power-saving logic may operate within in accordance with various embodiments of the disclosure;

FIG. 2 is a conceptual illustration of a high availability switch pair in accordance with various embodiments of the disclosure;

FIG. 3 is a conceptual illustration of a plurality of peerings associated with a high availability switch pair in accordance with various embodiments of the disclosure;

FIG. 4 is a conceptual illustration of a high availability access point pair in accordance with various embodiments of the disclosure;

FIG. 5 is a flowchart depicting a process for entering lower-power states in a network device in accordance with various embodiments of the disclosure;

FIG. 6 is a flowchart depicting a process for exiting lower-power states in a network device in accordance with various embodiments of the disclosure;

FIG. 7 is a flowchart depicting a process for utilizing link pulses to exit a lower-power state in accordance with various embodiments of the disclosure;

FIG. 8 is a flowchart depicting a process for exiting a lower-power state in the absence of link pulses in accordance with various embodiments of the disclosure;

FIG. 9 is a flowchart depicting a process for exiting a lower-power state after receiving a predetermined number of link pulses in accordance with various embodiments of the disclosure; and

FIG. 10 is a conceptual block diagram of a device suitable for configuration with a power-saving logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that can enter deep standby lower-power state utilizing a physical level connection while retaining connections with neighboring devices, thus conserving a greater amount of electricity. By entering this deeper state of sleep, there can be a measurable increase in overall sustainability while fostering better network designs. In many embodiments, a unique protocol can be utilized that can allow standby or other network devices to enter a deeper state of sleep without sacrificing failover performance. This can improve the overall operation of a network and associated network devices by allowing for more energy efficient network designs and overall energy management.

In various embodiments, when the standby network device goes into a deep standby state, it can be placed into a lower-power state that requires a much lower amount of power than typical sleep or low-power states. In a number of embodiments, this type of lower-power state can include shutting down one or more processors, fans, interfaces, transceivers, power supplies, and/or any other non-essential component as described in more detail below. For example, certain core/distribution switch network devices can (based on average United States energy costs and a typical 1500-Watt power supply) can consume approximately two-thousand dollars of electricity per year. In numerous embodiments described herein, the amount of electricity that can be saved can be over eighty percent, thus cutting electricity costs by four-fifths, depending on usage. These savings can multiply depending on the number of similar devices on a network.

In many embodiments, the network devices configured for the lower-power state can be paired with other devices and can act as a backup/failover device. This pair of network devices are often connected with a network connection. Often, this network connection can be a physical connection, such as, but not limited to, Ethernet connections. As those skilled in the art will recognize, network connections and other operations can comply with the open system interconnection (OSI) model. The OSI model describes various layers of connections, including a physical (PHY) layer. A number of embodiments described herein can utilize this PHY connection as keepalive connections.

Once a connection via a PHY layer has been established, certain embodiments can transmit a series or plurality of link pulses. In some embodiments, the link pulses will be transmitted from the device in the lower-power state to the associated neighbor device (such as the active device within the pair). In this way, the link pulses can be configured to ensure that various neighbor devices recognize that the lower-power device is still active and that any peer relationship with it should not be discarded, torn-down, or otherwise stopped. The lower-power network device operating in a deep standby state can periodically transmit these link pulses as a keepalive signal.

In more embodiments, the link pulses can be received by the lower-power network device. In this way, a power-saving logic can be configured to listen for these received link pulses from various neighbor devices in order to respond to various events. In some embodiments, the lack of a received link pulse after a certain time interval can indicate that the neighbor device has been taken offline and the lower-power network device should exit the lower-power state and wake up to initiate various operations in response. This can often be to replicate the operations of the neighbor device as a failover network device.

In certain embodiments, the network device operating in a lower-power state may require to be updated periodically on the state of one or more neighboring devices. As those skilled in the art will recognize, various state data should be present if certain operations are to be executed by the lower-power device after waking up. Therefore, some embodiments, may be configured to wake after a certain number of received link pulses (i.e., wakeup signals), request and subsequently receive state data associated with neighboring devices and then re-enter the lower-power state. In this way, the network devices in deep sleep/standby states can remain current on the states of neighboring devices with minimal electricity cost.

Additionally, it is recognized that the terms “power” and “energy” are often used interchangeably in many colloquial settings but have distinct differences. Specifically, energy is accepted as the capacity of a system or device to do work (such as in kilowatt-hours (kWh)), while power is the rate at which energy is transferred (often in watts (W)). Power represents how fast energy is being used or produced. With this in mind, it should be understood that various elements of the present disclosure may utilize common terms like “power lines,” “power grids,” power source,” “power consumption,” and “power plant” when describing energy delivery and utilization, even though those skilled in the art will recognize that those elements are delivering or processing energy (specifically electricity) at a certain rate of power. References to these terms are utilized herein specifically to increase the ease of reading.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

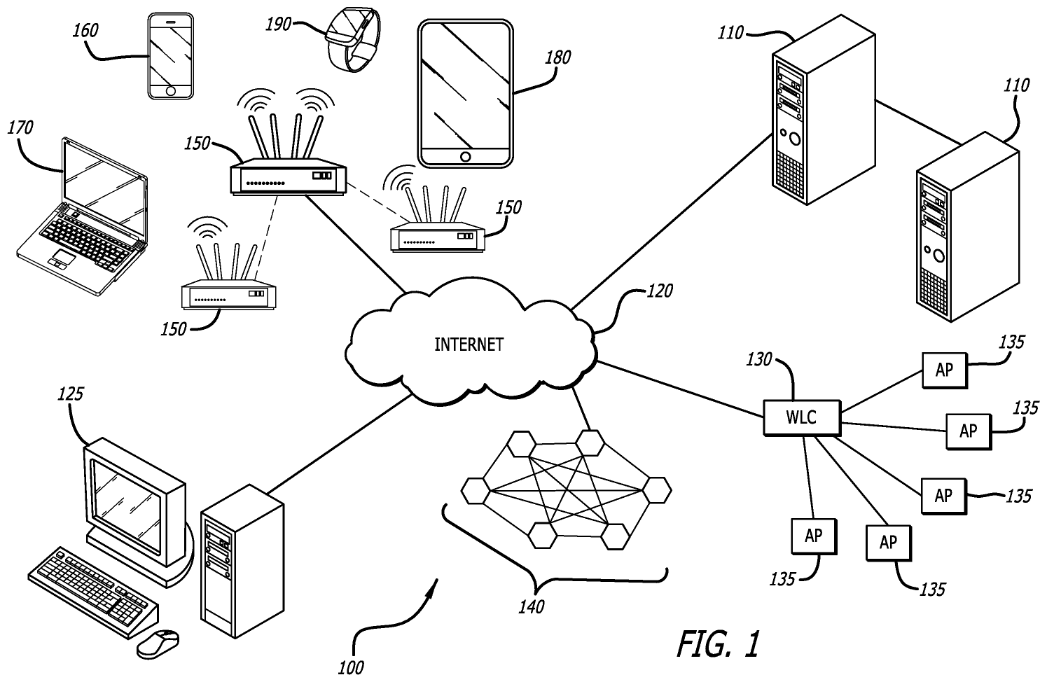

Referring to FIG. 1, a conceptual network diagram of various environments that a power-saving logic may operate within in accordance with various embodiments of the disclosure is shown. Those skilled in the art will recognize that a power-saving logic can be comprised of various hardware and/or software deployments and can be configured in a variety of ways. In some non-limiting examples, the power-saving logic can be configured as a standalone device, exist as a logic within another network device, be distributed among various network devices operating in tandem, or remotely operated as part of a cloud-based network management tool.

In many embodiments, the network 100 may comprise a plurality of devices that are configured to transmit and receive data for a plurality of clients. In various embodiments, cloud-based centralized management servers 110 are connected to a wide-area network such as, for example, the Internet 120. In further embodiments, cloud-based centralized management servers 110 can be configured with or otherwise operate a power-saving logic. The power-saving logic can be provided as a cloud-based service that can service remote networks, such as, but not limited to the deployed network 140. In these embodiments, the power-saving logic can be a logic that receives data from the deployed network 140 and generates predictions, receives environmental sensor signal data, and perhaps automates certain decisions or protective actions associated with the network devices. In certain embodiments, the power-saving logic can generate historical and/or algorithmic data in various embodiments and transmit that back to one or more network devices within the deployed network 140.

However, in additional embodiments, the power-saving logic may be operated as distributed logic across multiple network devices. In the embodiment depicted in FIG. 1, a plurality of network access points (APs) 150 can operate as a power-saving logic in a distributed manner or may have one specific device facilitate the detection of movement for the various APs. This can be done to provide sufficient needs to the network of APs such that, for example, a minimum bandwidth capacity may be available to various devices. These devices may include but are not limited to mobile computing devices including laptop computers 170, cellular phones 160, portable tablet computers 180 and wearable computing devices 190.

In still further embodiments, the power-saving logic may be integrated within another network device. In the embodiment depicted in FIG. 1, the wireless LAN controller 130 may have an integrated power-saving logic that it can use to generate predictions, and perhaps detect anomalous movements regarding the various APs 135 that it is connected to, either wired or wirelessly. In this way, the APs 135 can be configured such that they can read and report various signal levels and environmental sensor signals to the WLC 130. In still more embodiments, a personal computer 105 may be utilized to access and/or manage various aspects of the power-saving logic, either remotely or within the network itself. In the embodiment depicted in FIG. 1, the personal computer 105 communicates over the Internet 120 and can access the power-saving logic within the cloud-based centralized management servers 110, the network APs 150, or the WLC 130 to modify or otherwise monitor the power-saving logic.

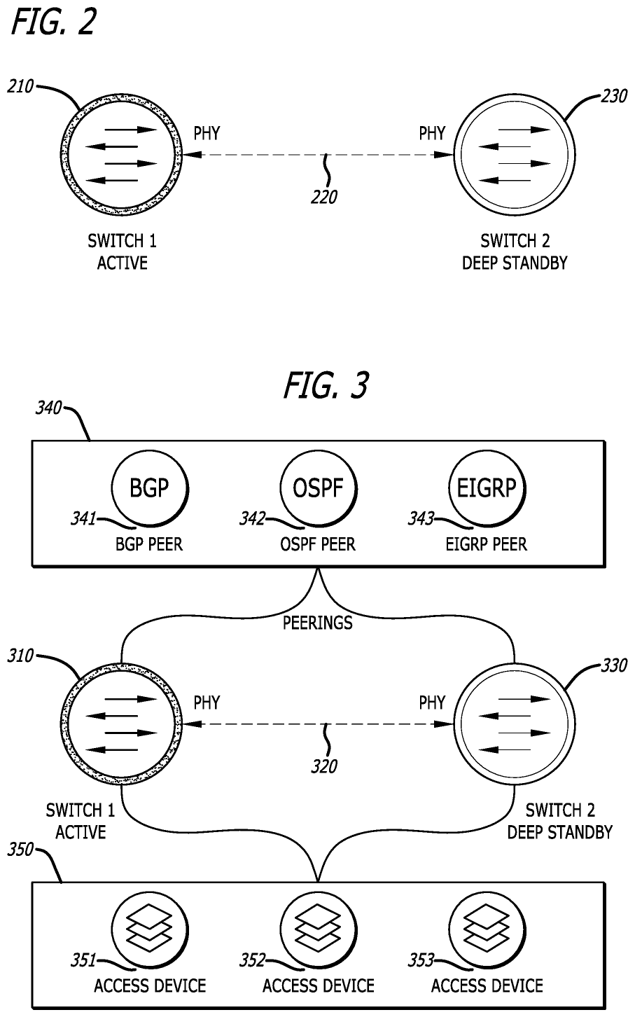

Although a specific embodiment for a conceptual network diagram of a various environments that a power-saving logic operating on a plurality of network devices suitable for carrying out the various steps, processes, methods, and operations described herein is discussed with respect to FIG. 1, any of a variety of systems and/or processes may be utilized in accordance with embodiments of the disclosure. For example, the power-saving logic may be implemented across a variety of the systems described herein such that some detections and/or communications are generated and/or received on a first system type (e.g., remotely), while additional steps or actions are generated or determined in a second system type (e.g., locally). The elements depicted in FIG. 1 may also be interchangeable with other elements of FIGS. 2-10 as required to realize a particularly desired embodiment.

Referring to FIG. 2, a conceptual illustration of a high availability switch pair in accordance with various embodiments of the disclosure is shown. In many embodiments, a high availability switch pair can include at least an active switch 210 (shown as Switch 1 Active), and a deep standby switch 230 (shown as Switch 2 Deep Standby). In additional embodiments, the active switch 210 and deep standby switch 230 can be connected by a physical connection 220. As depicted in the embodiment of FIG. 2, the physical connection 220 is a PHY connection in accordance with an OSI model. As described in more detail below, the physical connection 220 can be used to communicate a plurality of link pulses back and forth. In some embodiments, the deep standby switch 230 can be in normal operation in tandem with the active switch 210 until it is determined the deep standby switch 230 can enter a lower-power state. In further embodiments, the deep standby switch 230 can act as a failover, or other type of backup device, such that when the active switch 210 encounters issues, or is otherwise inoperable, the deep standby switch 230 can exit the lower-power state and resume one or more operations of the active switch 210.

Although a specific embodiment for a high availability switch pair suitable for carrying out the various steps, processes, methods, and operations described herein is discussed with respect to FIG. 2, any of a variety of systems and/or processes may be utilized in accordance with embodiments of the disclosure. For example, the high availability pair may include more than two devices depending on the application desired. Similarly, a network can be designed with a plurality of pairs. The elements depicted in FIG. 2 may also be interchangeable with other elements of FIGS. 1 and 3-10 as required to realize a particularly desired embodiment.

Referring to FIG. 3, a conceptual illustration of a plurality of peerings associated with a high availability switch pair in accordance with various embodiments of the disclosure is shown. Similarly, to the embodiment depicted in FIG. 2, various embodiments may comprise a high availability switch pair that can include at least an active switch 310 (shown as Switch 1 Active), and a deep standby switch 330 (shown as Switch 2 Deep Standby). In additional embodiments, the active switch 310 and deep standby switch 330 can be connected by a physical connection 320. As depicted in the embodiment of FIG. 3, the physical connection 320 is a PHY connection in accordance with an OSI model.

Both the active switch 310 and the deep standby switch 330 can be connected to various other network devices. The active switch 310 and the deep standby switch 330 can be in communication with a plurality of access devices 350 including a first access device 351, a second access device 352, and a third access device 353. However, any number of access devices or other network devices can be in communication with the pair. In a number of embodiments, the active switch 310 and the deep standby switch 330 can have a plurality of peerings 340. In the embodiment depicted in FIG. 3, the peerings 340 can include a border gateway protocol (BGP) peer 341, an open shortest path first (OSPF) peer 342, and an enhanced interior gateway routing protocol (EIGRP) peer 343. These peers can be utilized for routings and for other network purposes.

Those skilled in the art will recognize, that peering in networking refers to the establishment of relationships between two networking entities, serving various purposes depending on the context. In routing protocols like BGP, OSPF, and EIGRP, routers form peer relationships to exchange critical routing information, facilitating efficient network communication and decision-making. Peering is also prevalent in peer-to-peer networks, where devices communicate directly, bypassing a central server. In scenarios like load balancing, peers collaborate to distribute traffic and enhance fault tolerance, contributing to improved resource utilization.

Additionally, peering is integral to security, authentication, and VPN setups, ensuring secure communications. It is employed in network redundancy architectures, where peers provide backup to maintain continuous service availability. In the broader context of the internet, ISPs and large networks peer through BGP to exchange traffic and enhance connectivity between autonomous systems. Understanding the specific purpose of peering is essential, whether for routing, communication, load balancing, collaboration, security, redundancy, or interconnecting autonomous systems.

Although a specific embodiment for a plurality of peerings associated with a high availability switch pair suitable for carrying out the various steps, processes, methods, and operations described herein is discussed with respect to FIG. 3, any of a variety of systems and/or processes may be utilized in accordance with embodiments of the disclosure. For example, the number of network devices in communication with a high availability pair can vary depending on the application desired. The elements depicted in FIG. 3 may also be interchangeable with other elements of FIGS. 1-2 and 4-10 as required to realize a particularly desired embodiment.

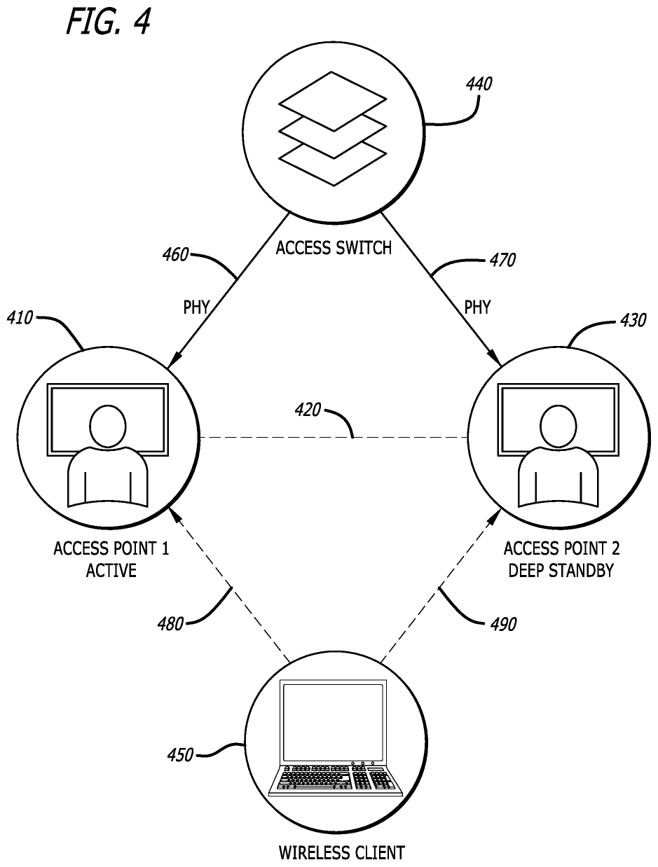

Referring to FIG. 4, a conceptual illustration of a high availability access point pair in accordance with various embodiments of the disclosure is shown. In many embodiments, a network can comprise a plurality of access points. These access points may be configured in various high availability pairs. In the embodiment depicted in FIG. 4, an active access point 410 (shown as Access Point 1 Active) is paired with a deep standby access point 430 (shown as Access Point 2 Deep Standby). The pair can be connected directly to each other through a wireless communication 420. In such an arrangement, if an event occurs wherein a the active access point 410 becomes inoperable or otherwise becomes unavailable, the deep standby access point 430 can exit a lower-power mode and begin to mimic one or more operations performed by the neighbor active access point 410.

However, both the active access point 410 and the deep standby access point 430 can be connected to an access switch 440 wherein the active access point connection 460 and the deep standby access point connection 470 is a physical connection, and can be a PHY connection in accordance with the OSI model. As is typical with most networks with a plurality of access points, a wireless client 450 can connect to various access points including to the active access point 410 through a first access point connection 480 and the deep standby access point 430 through a second access point connection 490. However, connection to the deep standby access point 430 may not be possible when it has entered a lower-power state.

In various embodiments, the arrangement depicted in FIG. 4 can be utilized for more than just providing redundancy. If the access points have some physical link (such as to the access switch 440), a virtual connection though an upstream, or downstream device can be created. In certain embodiments, a radio and/or Bluetooth signal can be utilized as a pulse link. This could be utilized in wireless networks where redundancy is critical. In these embodiments, a high availability pair can be deployed such that the deep standby access point 430 is allowed to enter a lower-power state until an event that indicates that it should be activated. This can be done in certain embodiments when seamless upgrades of access points are needed and can avoid downtime on the network.

Although a specific embodiment for a conceptual illustration of a high availability access point pair suitable for carrying out the various steps, processes, methods, and operations described herein is discussed with respect to FIG. 4, any of a variety of systems and/or processes may be utilized in accordance with embodiments of the disclosure. For example, specific layout of the topology 400 can vary greatly depending on the specific network being managed. The elements depicted in FIG. 4 may also be interchangeable with other elements of FIGS. 1-3 and 5-10 as required to realize a particularly desired embodiment.

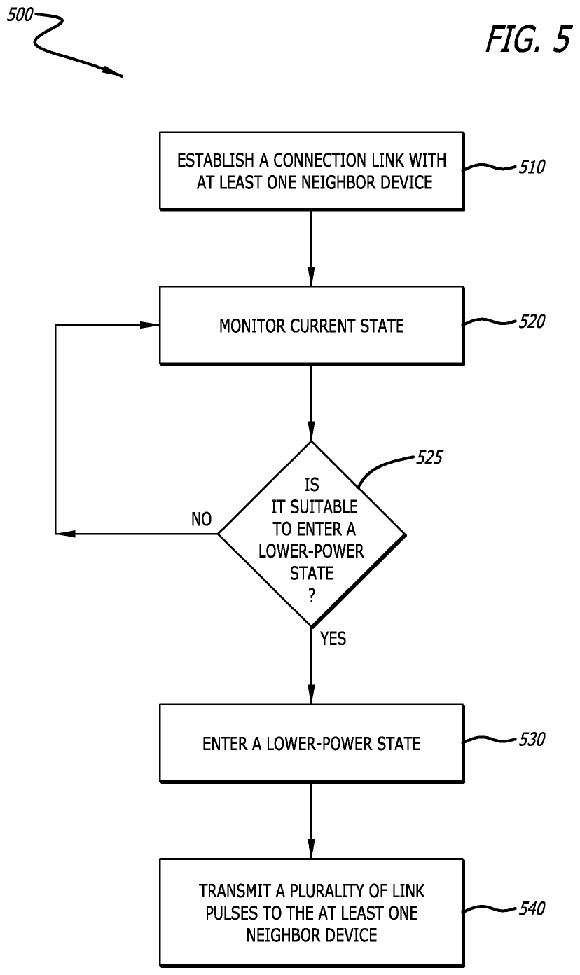

Referring to FIG. 5, a flowchart depicting a process 500 for entering lower-power states in a network device in accordance with various embodiments of the disclosure is shown. In many embodiments, the process 500 can establish a connection link with at least one neighbor device (block 510). As shown in the embodiments depicted above, a network device can be connected to another network device in a pairing. However, many different network devices can be connected to each other.

In a number of embodiments, the process 500 can monitor the current state (block 520). The current state can be associated with the current amount of connection activity, or the state of the connection as available or not, etc. The monitoring can also occur in a continuous fashion or over a periodic time interval.

In more embodiments, the process 500 can determine if it is suitable to enter a lower-power state (block 525). When it is not suitable to enter a lower-power state, the process 500 can again continue to monitor the current state (block 520). However, when it is determined that it is suitable, the process can enter a lower-power state (block 530). As described above, a device can enter a lower-power state by disengaging or otherwise powering down various components, including components that are typically not powered down with the exception of components associated with the physical connection.

In response, various embodiments of the process 500 can transmit a plurality of link pulses to the at least one neighbor device (block 540). The link pulses can be utilized to maintain connections with the neighbor devices. The link pulses can also be transmitted on various physical connections, but may, in certain embodiments, be transmitted wirelessly. The components necessary to transmit these pulses can be maintained but can be configured to utilize minimal power compared to typical low-power states.

Although a specific embodiment for a process for entering lower-power states in a network device suitable for carrying out the various steps, processes, methods, and operations described herein is discussed with respect to FIG. 5, any of a variety of systems and/or processes may be utilized in accordance with embodiments of the disclosure. For example, the number of components, the direction of communication, and/or the link pulses sent may vary based on the specific deployment and/or configuration. The elements depicted in FIG. 5 may also be interchangeable with other elements of FIGS. 1-4 and 6-10 as required to realize a particularly desired embodiment.

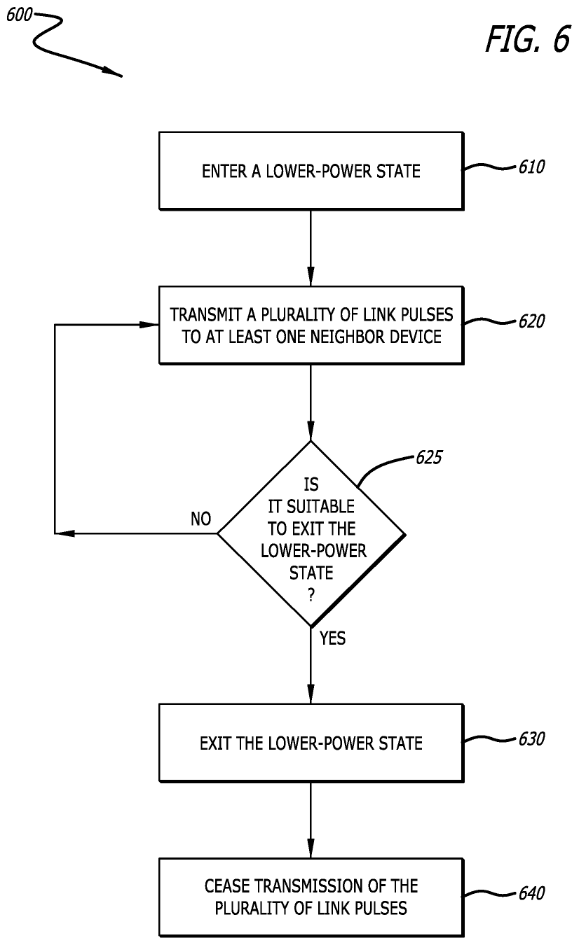

Referring to FIG. 6, a flowchart depicting a process 600 for exiting lower-power states in a network device in accordance with various embodiments of the disclosure is shown. In many embodiments, the process 600 can enter a lower-power state (block 610). As described above, a device can enter a lower-power state by disengaging or otherwise powering down various components, including components that are typically not powered down with the exception of components associated with the physical connection.

In a number of embodiments, the process 600 can transmit a plurality of link pulses to at least one neighbor device (block 620). The link pulses can be utilized to maintain connections with the neighbor devices. The link pulses can also be transmitted on various physical connections, but may, in certain embodiments, be transmitted wirelessly. The components necessary to transmit these pulses can be maintained but can be configured to utilize minimal power compared to typical low-power states.

In additional embodiments, the process can determine if it is suitable to exit the lower-power state (block 625). When it is not suitable to exit a lower-power state, the process 600 can again continue to transmit a plurality of link pulses to at least one neighbor device (block 620). However, when it is determined that it is suitable, the process can exit a lower-power state (block 630). The suitableness can be in response to an event or can be after various predetermined intervals or times, such as those described in more detail below. In more embodiments, the lower-power state can include powering up only a portion of the components necessary to gather updated state data.

In further embodiments, the process 600 can cease transmission of the plurality of link pulses (block 640). In certain embodiments, this cessation can occur prior to exiting the lower-power state. In still more embodiments, the cessation can occur in tandem with exiting the lower-power state.

Although a specific embodiment for a process 600 for engaging a service protection configuration with an agent suitable for carrying out the various steps, processes, methods, and operations described herein is discussed with respect to FIG. 6, any of a variety of systems and/or processes may be utilized in accordance with embodiments of the disclosure. For example, in some embodiments, the transmission of link pulses may conclude with a series or other combination such that information is communicated to various neighbor devices that the lower-power state has been terminated, etc. The elements depicted in FIG. 6 may also be interchangeable with other elements of FIGS. 1-5 and 7-10 as required to realize a particularly desired embodiment.

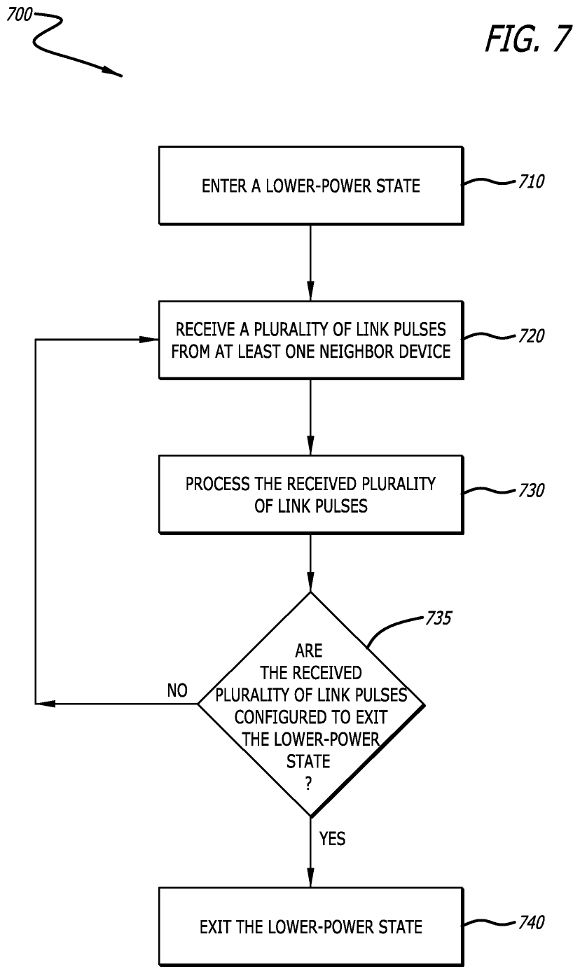

Referring to FIG. 7, a flowchart depicting a process 700 for utilizing link pulses to exit a lower-power state in accordance with various embodiments of the disclosure is shown. In many embodiments, the process 700 can enter a lower-power state (block 710). Similar to the embodiment described with respect to FIG. 6, a device can enter a lower-power state by disengaging or otherwise powering down various components, including components that are typically not powered down with the exception of components associated with the physical connection.

In further embodiments, the process 700 can receive a plurality of link pulses from at least one neighbor device (block 720). Similar to the link pulses sent by network devices in a lower-power state, the neighboring devices can likewise send link pulse signals back to the deep standby devices. As described in more detail below, these link pulses can be utilized in various ways.

In a number of embodiments, the process 700 can process the received plurality of link pulses (block 730). In certain embodiments, the processing can be done on a physical level, meaning that various analog components can change states over time based on the reception of link pulses. However, in some embodiments, the process 700 can utilize one or more components that are powered up to digitally capture and process the received link pulses.

In additional embodiments, the process 700 can determine if the received link pulses are configured to exit the lower-power state (block 735). As discussed in more detail below, the configuration of the link pulses can be in a format of time period intervals, level, or number of received link pulses. If it is determined that it is not suitable to exit the lower-power state, the process 700 can continue to receive a plurality of link pulses from neighboring devices (block 720). However, if it is determined that the link pulses are configured to exit the lower-power state, the process 700 can exit the lower-power state (block 740).

Although a specific embodiment for a process 700 for utilizing link pulses to exit a lower-power state suitable for carrying out the various steps, processes, methods, and operations described herein is discussed with respect to FIG. 7, any of a variety of systems and/or processes may be utilized in accordance with embodiments of the disclosure. For example, in some embodiments, the process 700 may receive link pulses from multiple neighbor devices can keep a separate count or otherwise make determinations based on each individual neighbor device and any associated state. The elements depicted in FIG. 7 may also be interchangeable with other elements of FIGS. 1-6 and 8-10 as required to realize a particularly desired embodiment.

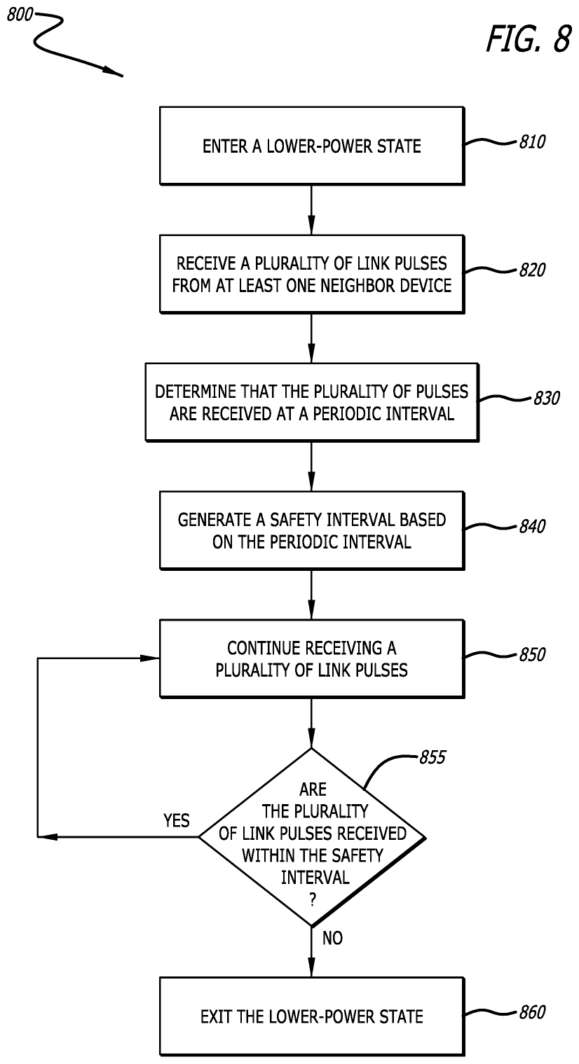

Referring to FIG. 8, a flowchart depicting a process 800 for exiting a lower-power state in the absence of link pulses in accordance with various embodiments of the disclosure is shown. In many embodiments, the process 800 can enter a lower-power state (block 810). As described above, a device can enter a lower-power state by disengaging or otherwise powering down various components, including components that are typically not powered down with the exception of components associated with the physical connection.

In a number of embodiments, the process 800 can receive a plurality of link pulses from at least one neighbor device (block 820). Similar to the link pulses sent by network devices in a lower-power state, the neighboring devices can likewise send link pulse signals back to the deep standby devices. As described in more detail below, these link pulses can be utilized in various ways.

In additional embodiments, the process 800 can determine that the plurality of pulses are received at a periodic interval (block 830). The periodic interval can be determined based on measuring the time between each of the plurality of link pulses received. In some embodiments, the determination can be achieved by a response in one or more components receiving a change in voltage or other signal.

In various embodiments, the process 800 can generate a safety interval based on the periodic interval (block 840). The safety interval can be based on an average of previously received pulse links with an additional buffer added. The amount of buffer added may be dynamically created based on the determined time between the received link pulses. The safety interval may be a predetermined interval set by the manufacturer prior to deployment. However, in certain embodiments, a user or other network administrator can manually set the safety interval.

In further embodiments, the process 800 can continue receiving a plurality of link pulses (block 850). The link pulses can be received from one or more neighbor devices. In certain embodiments, the link pulses can be received over a physical connection, such as the PHY connection in accordance with the OSI model.

In more embodiments, the process 800 can determine if the plurality of link pulses are received within the safety interval (block 855). This determination can be achieved by marking a first time of a received link pulse, and marking a second time of the next received link pulse and then comparing the first and second time against the safety interval. In some embodiments, the first time can be marked and then a progression of time can be marked in some manner and can be compared against the safety interval. When it is determined that the link pulses are received within the safety interval, the process 800 can continue receiving a plurality of link pulses (block 850). However, when the process 800 determines that the link pulses are not within the safety interval, then the process 800 can exit the lower-power state (block 860). In other words, an event may occur wherein the process 800 is failing to receive a predetermined number of link pulses from the neighbor device in a predetermined time interval, thus triggering the exiting of the lower-power state. In more embodiments, the lower-power state can include powering up only a portion of the components necessary to gather updated state data.

Although a specific embodiment for a process 800 for exiting a lower-power state in the absence of link pulses suitable for carrying out the various steps, processes, methods, and operations described herein is discussed with respect to FIG. 8, any of a variety of systems and/or processes may be utilized in accordance with embodiments of the disclosure. For example, the safety interval can be dynamically changed based on one or more events, based on current connectivity status, or other networking states. The elements depicted in FIG. 8 may also be interchangeable with other elements of FIGS. 1-7 and 9-10 as required to realize a particularly desired embodiment.

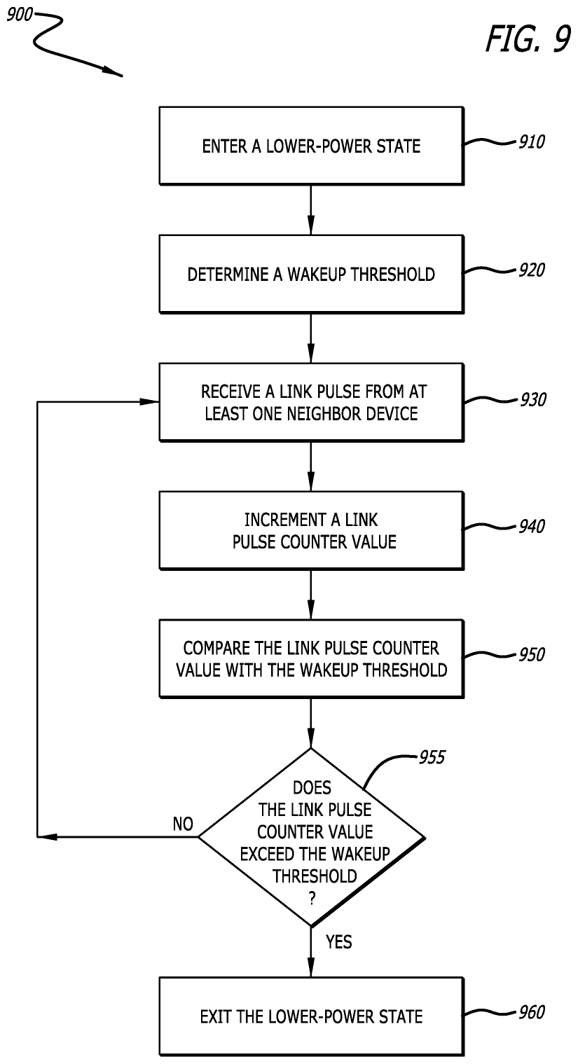

Referring to FIG. 9, a flowchart depicting a process 900 for exiting a lower-power state after receiving a predetermined number of link pulses in accordance with various embodiments of the disclosure is shown. In many embodiments, the process 900 can enter a lower-power state (block 910). Similar to the embodiments described with respect to FIGS. 6-8, a device can enter a lower-power state by disengaging or otherwise powering down various components, including components that are typically not powered down with the exception of components associated with the physical connection.

In a number of embodiments, the process 900 can determine a wakeup threshold (block 920). In some embodiments, a network device can be configured to wake up after receiving a predetermined number of link pulses. The specific number can be determined dynamically based on one or more conditions. However, in certain embodiments, the wakeup threshold may be set during the manufacturing process. In further embodiments, the wakeup threshold may be set from a predefined list of values based on one or more network conditions.

In various embodiments, the process 900 can receive a link pulse from at least one neighbor device (block 930). Similar to the link pulses sent by network devices in a lower-power state, the neighboring devices can likewise send link pulse signals back to the deep standby devices. As described in more detail below, these link pulses can be utilized in various ways.

In more embodiments, the process 900 can increment a link pulse counter value (block 940). As those skilled in the art will recognize, the counter value can be implemented in various ways. For example, a digital value can be stored within a memory. However, in certain embodiments, an analog or similar setup can be configured such that an electrical value is increased upon each link pulse received. In this way, digital components may be avoided to be powered on. However, in some embodiments, specific components may be configured such that a digital value can be stored with minimal power.

In additional embodiments, the process 900 can compare the link pulse counter value with the wakeup threshold (block 950). This comparison can be done in with a digital value by comparing the value stored in one location in memory with another. In certain embodiments, the comparison can be analog in nature and compare the signal present versus another component that is configured to act in response to a signal above the wakeup threshold. However, as those skilled in the art will recognize, this comparison can be accomplished in a number of ways.

In further embodiments, the process 900 can determine if the link pulse counter value exceeds the wakeup threshold (block 955). When it is determined that the value does not exceed the wakeup threshold, the process 900 can continue to receive a link pulse from at least one neighbor device (block 930). However, when it is determined that the link pulse counter value does exceed the wakeup threshold, the process 900 can exit the lower-power state (block 960). In more embodiments, the lower-power state can include powering up only a portion of the components necessary to gather updated state data. However, various embodiments may exit lower-power states to continue operations.

Although a specific embodiment for a process 900 for a process 900 for exiting a lower-power state after receiving a predetermined number of link pulses suitable for carrying out the various steps, processes, methods, and operations described herein is discussed with respect to FIG. 9, any of a variety of systems and/or processes may be utilized in accordance with embodiments of the disclosure. For example, certain embodiments may provide for exiting the lower-power state, gathering state data from one or more neighbor devise associated with the link pulses being counted, and then returning to the lower-power state. The elements depicted in FIG. 9 may also be interchangeable with other elements of FIGS. 1-8 and 10 as required to realize a particularly desired embodiment.

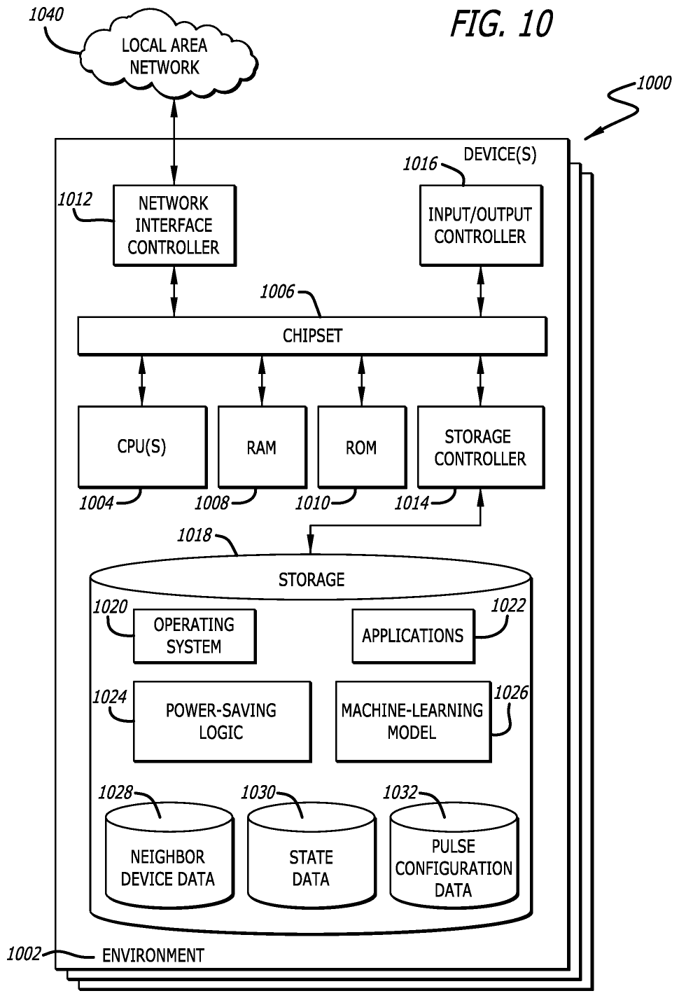

Referring to FIG. 10, a conceptual block diagram of a device 1000 suitable for configuration with a power-saving logic 1024 in accordance with various embodiments of the disclosure is shown. The embodiment of the conceptual block diagram depicted in FIG. 10 can illustrate a conventional server computer, workstation, desktop computer, laptop, tablet, network device, access point, router, switch, e-reader, smart phone, centralized management service, or other computing device, and can be utilized to execute any of the application and/or logic components presented herein. The device 1000 may, in some examples, correspond to physical devices and/or to virtual resources and embodiments described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002.

The chipset 1006 can provide an interface to communicatively couple a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-10. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10 and can include other components that are not explicitly shown in FIG. 10 or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a power-saving logic 1024 that can be configured to perform one or more of the various steps, processes, operations, and/or other methods that are described above. While the embodiment shown in FIG. 10 depicts a logic focused on directing devices to enter and/or exit lower-power states, it is contemplated that a more general “energy management” logic may be utilized as well or in lieu of such logic. Often, the power-saving logic 1024 can be a set of instructions stored within a non-volatile memory that, when executed by the controller(s)/processor(s) 1004, can carry out these steps, etc. In some embodiments, the power-saving logic 1024 may be a client application that resides on a network-connected device, such as, but not limited to, a server, switch, personal or mobile computing device in a single or distributed arrangement. In certain embodiments, the power-saving logic 1024 can be a dedicated hardware device, cloud-based service, or be configured into a system on a chip package (FPGA, ASIC and the like).

In a number of embodiments, the storage 1018 can include neighbor device data 1028. As discussed above, the neighbor device data 1028 can be collected in a variety of ways and may involve data related to multiple network devices, agents, and the like. The neighbor device data 1028 may be associated with devices deployed across an entire network or on a portion/partition of a network. This may also include a relationship of the various associated network devices that are associated with each other. As those skilled in the art will recognize, neighbor device data 1028 can be configured to track a variety of different aspects of a network, it's devices, and associated telemetry.

In various embodiments, the storage 1018 can include state data 1030. As described above, state data 1030 can be associated with various network devices, data centers, applications, or other processes within a network. Each device, and even workload may have additional state data 1030 associated with it including the configuration of one or more workloads, network devices, data centers, applications, or the like, including, but not limited to, telemetry data, etc. In various embodiments, state data 1030 may be utilized to describe additional attributes of the network devices, including one of: bandwidth usage, latency, traffic patterns, quality-related metrics, throughput, performance, security-related events, resource utilization, and/or scalability traits. As those skilled in the art will recognize, state data 1030 may be configured to include any data relevant to allow for the direct replacement of operations by a failover/backup device.

In still more embodiments, the storage 1018 can include pulse configuration data 1032. As discussed above, pulse configuration data 1032 may be related to any type of data relative to the receiving, processing, and/or transmitting of link pulses. For example, the type of link pulses that can be transmitted can be determined by the pulse configuration data 1032. Likewise, the pulse configuration data 1032 can provide direction on how to handle or otherwise process received link pulses such as how to count them, determining where they were received from, parsing them for relevant data and/or formats, etc. In more embodiments, the pulse configuration data 1032 can be configured to direct a network device on when and/or where to transmit a link pulse.

In still more embodiments, the storage 1018 can include protection configuration data 1034. As discussed above, protection configuration data 1034 can be transmitted to various agents to secure and prevent unauthorized services from being processed. The protection configuration data 1034 can be combined or utilized in tandem with various other configuration data. In some embodiments, the protection configuration data may be data received from one or more agents deployed on the network. In certain embodiments, the protection configuration data 1034 can be received via one or more web-based protocols which can be stored on a temporary basis or parsed and stored in a long-term way within the protection configuration data 1034.

Finally, in many embodiments, data may be processed into a format usable by a machine-learning model 1026 (e.g., feature vectors, etc.), and or other pre-processing techniques. The machine learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn the pattern of a network's current setup and/or any security needs of various network devices and generate predictions, configurations, and/or confidence levels regarding when to enter and/or exit a lower-power state, how to process link pulses, etc. In some embodiments, the ML model 1026 can be configured to determine which method of generating those predictions would work best based on certain conditions or with certain network devices.

The ML model(s) 1026 can be configured to generate inferences to make predictions or draw conclusions from data. An inference can be considered the output of a process of applying a model to new data. This can occur by learning from at least the neighbor device data 1028, state data 1030, pulse configuration data 1032, and/or the underlying algorithmic data and use that learning to predict future configurations, outcomes, and needs. These predictions are based on patterns and relationships discovered within the data. To generate an inference, such as a determination on anomalous movement, the trained model can take input data and produce a prediction or a decision/determination. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes. The training set of the ML model(s) 1026 can be provided by the manufacturer prior to deployment and can be based on previously verified data.

Although a specific embodiment for a device 1000 suitable for configuration with a power-saving logic 1024 suitable for carrying out the various steps, processes, methods, and operations described herein is discussed with respect to FIG. 10, any of a variety of systems and/or processes may be utilized in accordance with embodiments of the disclosure. For example, the device may be in a virtual environment such as a cloud-based network administration suite, or it may be distributed across a variety of network devices such that each acts as a device and the power-saving logic 1024 acts in tandem between the devices. The elements depicted in FIG. 10 may also be interchangeable with other elements of FIGS. 1-9 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each, and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
at least one network interface controller configured to provide access to a network; and
a memory communicatively coupled to the processor, wherein the memory comprises a power-saving logic that is configured to:
establish a connection link with at least one neighbor device;
determine that it is suitable to enter a lower-power state;
enter the lower-power state; and
transmit a plurality of link pulses to the at least one neighbor device.

2. The device of claim 1, wherein the plurality of link pulses are continuous.

3. The device of claim 1, wherein the plurality of link pulses are transmitted at a predetermined interval.

4. The device of claim 1, wherein the power-saving logic is further configured to:
determine that it is suitable to exit the lower-power state;
exit the lower-power state; and
cease transmission of the plurality of link pulses.

5. The device of claim 1, wherein the connection link is based on an open system interconnection (OSI) model.

6. The device of claim 5, wherein the connection link is at a physical (PHY) layer.

7. The device of claim 1, wherein the connection link is a wired connection.

8. The device of claim 1, wherein the power-saving logic is further configured to receive a plurality of link pulses from the at least one neighbor device.

9. The device of claim 8, wherein the power-saving logic is further configured to count a number of received link pulses from the at least one neighbor device.

10. The device of claim 9, wherein the power-saving logic is further configured to:
compare the count of received link pulses against a predetermined threshold; and
exit, in response to the count of received link pulses exceeding the predetermined threshold, a lower-power state.

11. The device of claim 10, wherein the power-saving logic is further configured to:
receive state data from the at least one neighboring device; and
re-enter the lower-power state.

12. The device of claim 8, wherein the power-saving logic is further configured to determine a time interval since a last received link pulse.

13. The device of claim 12, wherein the power-saving logic is further configured to:
compare the time interval against a predetermined threshold; and
exit, in response to the time interval exceeding the predetermined threshold, the lower-power state.

14. The device of claim 13, wherein the power-saving logic is further configured to:
receive state data from the at least one neighboring device; and
re-enter the lower-power state.

15. A device, comprising:
a processor;
at least one network interface controller configured to provide access to a network; and
a memory communicatively coupled to the processor, wherein the memory comprises a power-saving logic that is configured to:
establish a connection link with at least one neighbor device;
receive state data associated with the at least one neighbor device;
determine that it is suitable to enter a lower-power state;
enter the lower-power state;
exit, in response to an event, the lower-power state; and
initiate at least one operation based on the state data.

16. The device of claim 15, wherein the at least one operation is associated with the at least one neighbor device.

17. The device of claim 16, wherein the at least one operation is configured to mimic an operation performed by the at least one neighbor device.

18. The device of claim 15, wherein the event is receiving one or more link pulses configured to indicate a wakeup signal.

19. The device of claim 15, wherein the event is failing to receive a predetermined number of link pulses from the at least one neighbor device in a predetermined time interval.

20. A method of maintaining neighboring connections, comprising:
establishing a connection link with at least one neighbor device over a network;
determining that it is suitable to enter a lower-power state;
entering the lower-power state; and
transmitting a plurality of link pulses to the at least one neighbor device, wherein the plurality of link pulses are configured to maintain a connection with the at least one neighbor device.
